(19) United States
(12) Patent Application Publication
(10) Pub. No.: US 2008/0128647 A1
(43) Pub. Date: Jun. 5, 2008

(54) Valves and valve assemblies for fluid ports

(75) Inventor: Burrell E. Clawson, Newport Beach, CA (US)

Correspondence Address: STOUT, UXA, BUYAN & MULLINS LLP, 4 VENTURE, SUITE 300, IRVINE, CA, 92618, US

(73) Assignee: HUMITEK, INC., Newport Beach, CA (US)

(21) Appl. No.: 11/635,773

(22) Filed: Dec. 5, 2006

(51) Int. Cl. F16L 37/28

(52) U.S. Cl. 251/149.1

(57) ABSTRACT

New valves and valve assemblies for fluid ports are provided. The present valves and valve assemblies are straightforward in construction, are easy to manufacture and use, and are structured to be highly effective and reliable in use, for example, as check valves.

### BACKGROUND OF THE INVENTION

The present invention relates to valves, valve assemblies, port caps and fluid ports. More particularly, the present invention relates to valves and valve assemblies, for example and without limitation, check valves and valve assemblies, and port caps and fluid ports, for example and without limitation, dust caps and fluid ports, for example and without limitation, involved with or included in other apparatus or devices, which are relatively straightforward in construction and easy and inexpensive to manufacture and use.

Various apparatus and devices include ports through which fluids, such as gases and/or liquids, are introduced into and/or expelled from the apparatus or device. For example, and without limitation, medical devices, such as infusion systems, respiratory gas circuits, various catheter systems, etc., as well as many industrial and commercial apparatus/devices employ ports through which fluids can be introduced into the apparatus/device or extracted from the apparatus/device. A very useful example of such ports are those associated with luer fittings, which are conventionally employed to periodically couple an apparatus/device, such as a medical device, to an auxiliary piece of equipment, for example, a suction device, gas sample port, a monitor system and the like.

During the time no such auxiliary piece of equipment is being employed, the port associated with the female luer fitting is often covered or capped with a so-called dust cap to avoid atmospheric and handling contamination. Conventionally, such dust caps are fully threaded to compliment the full threads on the outer surface of the female luer fitting, so that the cap can be screwed onto and secured to the fitting.

The fluid port or passage in communication with the female luer fitting is often equipped with a valve. This valve acts as a check valve to prevent fluid from entering and/or leaving or exiting the fluid port, and can be opened, as desired, to allow fluid to be passed through the valved port.

These prior art valves function quite effectively. However, many such valves in current use are quite complicated in design and often include a number of separate components. This results in such valves being relatively expensive and difficult to manufacture, and ultimately expensive to use, thereby disadvantageously adding to costs, for example, health care costs, such as when used in disposable products. In addition, the relatively large number of separate parts, for example, moving parts, of such prior art valves tend to adversely effect the reliability and even the effectiveness of the valves.

The use of full threads on fluid ports and dust caps increases costs of producing such ports and caps. For example, these ports and caps are often produced from polymeric materials by molding, for example, injection molding, techniques. Molding threads onto fluid ports, for example, full threads or partial thread tabs on female luer fittings, and full threads on dust caps often requires an unthreading core or sidecores in the molding of the part. This processing adds to the cost of making the part, and ultimately to the cost of using the part, to the detriment of the consumer.

It would be advantageous to provide valves, valve assemblies port caps and fluid ports which address one or more of these concerns.

### SUMMARY OF THE INVENTION

New valves, valve assemblies, caps and fluid ports have been discovered. The present valves and valve assemblies are straightforward in construction, are easy and inexpensive to manufacture and use, and are highly effective and reliable in use. The present caps and fluid ports include coupling systems or mechanisms which provide substantial advantages, for example and without limitation, in terms of reduced cost and increased ease of manufacture, relative to prior art such parts which are fully threaded to provide for coupling.

In one broad aspect of the invention, valve assemblies are provided which comprise a fluid port and a valve member. The fluid port, for example, comprising a female luer fitting component, comprises a sidewall defining a hollow through space, for example, for the passage of fluid through the fluid port. The valve member comprises a valve body carried by the sidewall, and an end portion coupled to the sidewall, including at least one through slit having a normally closed configuration and an open configuration with the outer surface of the end portion curved inwardly toward the sidewall.

In another broad aspect of the invention, valve assemblies are provided comprising a fluid port and a valve member comprising a valve body carried by the sidewall of the fluid port, and an end portion, coupled to the valve body, having a curved structure including at least one through slit in a normally closed configuration.

In one useful embodiment, the valve member is of straightforward construction and is highly effective in the fluid port as a valve preventing fluid from entering and/or leaving the fluid port, for example a two way valve preventing fluid from entering and leaving the fluid port, when the at least one through slit is in the normally closed configuration. The valve member may be a single unitary structure, which is substantially different from certain prior art valves made up of multiple different parts.

An additional aspect of the invention involves valve members which comprise a valve body comprising a wall, for example, a sidewall, defining a hollow space; and an end portion, coupled to the valve body, and having a curved outer surface. The end portion includes at least one through slit in a normally closed configuration extending through the curved outer surface. The at least one through slit in the normally closed configuration is effective in preventing fluid from at least one of (a) entering the hollow space through the end portion and (b) leaving or exiting the hollow space through the end portion, advantageously preventing fluid from both (a) and (b). The valve members disclosed and discussed elsewhere herein are embodiments of the valve members in accordance with the present invention and are included within the scope of the present invention.

The fluid port may be in communication with a conduit, or may be a component of a conduit, of an apparatus or device through which fluid, e.g., liquid or gas, can flow. In one embodiment, the fluid port is a part of a luer fitting, for example, a female luer fitting, component.

The at least one through slit in the valve member is advantageously openable, from the normally closed configuration to an open configuration, by an opening device, such as another component of a luer fitting, for example, a male luer fitting component, being coupled to the fluid port, for example, being coupled to the female luer fitting component. In a very useful embodiment, the other component of the luer fitting and/or the fluid port are structured to prevent the other luer fitting component from passing into or through the at least one through slit in opening the at least one through slit. This feature protects the valve member, for example, the at least one through slit in the end portion of valve member from damage and prolongs the useful life of the valve.

In a useful embodiment, the fluid port is structured to form a seal, for example, a substantially fluid tight seal at the conditions of use, with an opening device structured to open, for example, mechanically open, the at least one through slit. For example, the sidewall of the fluid port may include an annular inwardly extending projection distal of the valve member. This projection is structured to form a seal, for example, a substantially fluid tight seal at the conditions of use, with an opening device structured to open, for example, mechanically open the at least one through slit. The term “distal” in this context refers to a location which is a distance away from the end portion of the valve member and a greater distance away from the valve body, for example, the end of the valve body opposing the end portion of the valve member.

The fluid port may be structured to form such a seal with an opening device before the at least one through slit is moved from its normally closed configuration to the open configuration. This feature advantageously provides a seal, for example, a substantially fluid tight seal, between the fluid port and the opening device before the at least one through slit is opened, thus reducing the risk of contamination and unwanted fluid leakage out of the fluid port. In one embodiment, the fluid port is structured to form such a seal with an opening device after, for example, substantially immediately after, the at least one through slit returns from the open configuration to the normally closed configuration, for example, by moving the opening device away from the at least one through slit. Providing such a seal after the at least one through slit returns to the closed configuration reduces the risk of contamination and unwanted fluid leakage out of the fluid port.

In the event the fluid port is a component of a luer fitting and the opening device is another component of a luer fitting, the fluid port and the other component of the luer fitting are structured to form a seal, for example, a substantially fluid tight seal at the conditions of use, when, advantageously both before and when the at least one through slit is in the open configuration, and even after the at least one through slit is returned from the open configuration to the closed configuration.

In one embodiment, the end portion of the valve member is structured to invert, for example, from a curved structure extending outwardly away from the sidewall of the valve member to a curved structure extending inwardly toward the sidewall, when sufficient mechanical pushing force is applied to the end portion, for example and without limitation, from the male luer fitting component, thereby causing the at least one through slit to open enough, that is to move to an open configuration, to allow fluid to pass through the end portion.

The end portion of the valve member may be structured so that the outer surface of the end portion extends or is toward the valve body, for example, is curved inwardly toward the valve body, when the at least one through slit is in the normally closed configuration. Such an inwardly extending or curved outer surface, and advantageously inwardly extending or curved end portion of the valve member, with the at least one through slit in the normally closed configuration is effective in preventing fluid flow exiting or leaving the fluid port through the end portion at a higher or larger pressure differential relative to having the outer surface or end portion extending or curved outwardly of the valve body.

In the embodiments in which the outer surface of the end portion or the end portion itself extends or is curved toward the valve body when the at least one through slit is in the normally closed configuration, the end portion is structured to move, for example, in response to the application of a sufficient mechanical pushing force to the end portion, further inwardly toward the valve body, thereby causing the least one through slit to open enough to allow fluid to pass through the end portion.

The end portion of the valve member has a thickness, for example, away from the at least one through slit, for example, sufficiently small to allow the end portion to flex from a normal position to an inverted position upon the application of an opening force, as described elsewhere herein. Such thickness may vary over a relatively large range, for example, depending on the size, material of construction and geometry of the end portion. For example, such thickness may be in a range of about 0.1 mm or less to about 1 mm or more. In one embodiment, the end portion has a rib area in proximity to the at least one through slit, for example, surrounding all or at least a portion of the slit, which has a local thickness greater than the thickness of the end portion, for example, about 10% or about 20% to about 50% or about 100% or more, greater than the thickness of the remainder of the end portion or greater than the thickness of the thinnest part of the end portion. This increased local thickness of the rib area advantageously is effective in maintaining the at least one through slit in the normally closed configuration.

The fluid port itself may include a support structure, for example, a wall or walled structure, in contact with the end portion, for example, with an outer region of the end portion, when the at least one through slit is in the normally closed configuration. The support structure advantageously is effective in maintaining the at least one through slit in the normally closed configuration. Such support structure may also be effective in maintaining the valve member in place relative to the fluid port.

Thus, the increased local thickness of the rib area and/or the support structure of the fluid port may be effective in maintaining the at least one through slit in the normally closed configuration in response to changes in fluid pressure for example, on the order of about 15 psi or about 10 psi or less pressure difference, in the fluid port, for example, on either side of the end portion. However, such increased local thickness and/or support structure should not unduly interfere with a desired movement of the end portion to cause the at least one through slit to assume an open configuration.

The fluid port may be constructed of any suitable material effective to function in accordance with the present invention in the desired application. In one embodiment, the fluid port comprises a polymeric material and is formed by a process comprising molding, for example injection molding.

The valve member may be constructed of any suitable material effective to function in accordance with the present invention in the desired application. The valve member, and in particular the end portion of the valve member, is sufficiently flexible so that the at least one through slit is movable, for example and advantageously, repeatedly moveable, between the normally closed configuration and the open configuration. The characteristics of the end portion of the valve, for example, the valve's strain with the at least one through slit in the open configuration, may be sufficient to cause the end portion to move back by itself, after removal of the pushing force from an opening device, to a position in which the at least one through slit is in the normally closed configuration. This self closing feature of the present valve is effective in reducing contamination and unwanted fluid leakage.

In one useful embodiment, the valve member comprises a flexible polymeric material. The material of construction of the valve member may be different than the material of construction of the fluid port. The valve member may comprise an elastomeric polymeric material. Examples of useful materials of construction for the valve member include, without limitation, natural rubbers, synthetic rubbers, silicone rubbers, silicone elastomers, polyurethane elastomers, other polymeric elastomers and the like and combinations thereof.

The valve body may be frictionally held to the sidewall of the fluid port and/or may be interference fitted to the sidewall. The outer surface of the valve body may be textured and/or roughened and/or otherwise modified to facilitate the valve body being securely carried by the sidewall of the fluid port. Advantageously, no adhesives, solvents and the like and/or no additional parts, for example, additional parts to retain the valve body in place, are employed in securing the valve body to the sidewall.

The present valve assemblies may be structured to be effective as a check valve with only a low pressure differential, for example, a pressure differential of about 15 psi or about 10 psi or less, across the at least one through slit in the normally closed configuration.

The at least one through slit in the end portion of the valve member may be of any suitable size(s), number of slits and configuration(s) effective to function as set forth herein. In one useful embodiment, the at least one through slit is selected from one through slit, a plurality of non-intersecting through slits, a plurality of intersecting through slits and combinations thereof. The at least one through slit may extend across substantially all or only a portion of the diameter of the end portion, for example, depending on the intended application of the valve, the geometry of the valve, the material of construction of the valve and the like factors.

In a very useful embodiment, the at least one through slit is mechanically openable without passing an opening device into or through the at least one through slit. This feature of the invention provides for opening the at least one through slit without risking damage to the slit or slits caused by contact with the opening device. In one embodiment, the fluid port is structured to prevent the opening device passing into or through the at least one through slit. For example, the sidewall of the fluid port may have one or more inwardly extending projections effective in limiting the travel of the opening device in the fluid port so that the opening device can cause the at least one through slit to assume the open configuration, while restricting the opening device from passing into or through the at least one through slit.

In a further broad aspect of the invention, valve members as described elsewhere herein are within the scope of the present invention.

In an additional broad aspect of the invention, apparatus are provided which comprise a port, for example and without limitation, a fluid port, having a sidewall having an outer surface and defining a hollow space; and at least two spaced apart splines extending radially outwardly from the outer surface. The splines are structured to yield when placed in contact with at least one thread, meaning to include a full thread or a partial thread or thread segment, on an inner wall of a port cap sized to be placed on the port, rotated relative to the port and secured to the port.

As used in this context, the term “port cap” refers to any component that is suitable for being so secured to the port, and may include, for example and without limitation, a dust cap, another fitting component and the like.

Although the port and the splines can be constructed of any suitable material effective to function in accordance with the present invention, in one very useful embodiment each of the port and the splines comprise a polymeric material. Examples of polymeric materials useful as materials of construction for the port and splines include, without limitation, thermoplastic polymeric materials, such as polyolefins, for example, polyethylene, polypropylene, ethylene/propylene copolymers and the like, polycarbonates, polyesters, polyamides and the like and mixtures thereof and combinations thereof.

In one embodiment, the splines are resistant to being stripped. For example, the splines may be sufficiently resilient, for example may be sufficiently thin and/or pliable and/or soft, so that if the user turns a threaded fitting too hard against the splines, once the fitting bottoms out it does not strip the splines. In other words, the splines may be constructed to have or otherwise have sufficient resilience to “bounce back up” sufficiently enough after the threaded fitting passes that the port remains securely retained or secured to a port cap even after a deliberate attempt to strip the splines occurs. Thus, in one embodiment, the splines are structured to be resistant to being stripped.

In one useful embodiment, the port and the splines are a single unitary structure. For example, the port and splines may comprise the same polymeric material, and together form a single unitary molded structure.

In one embodiment, the present apparatus further comprises the port cap. The port cap may be constructed of any suitable material effective to function in accordance with the present invention. Examples of suitable polymeric materials useful as materials of construction for the port cap include, without limitation, the polymeric materials set forth herein as materials of construction for the fluid port and splines. Advantageously, the thread or threads of the port cap are somewhat harder or stiffer than the splines to facilitate the thread or threads causing the splines to yield in securing the port cap to the port. However, it should be noted that the thread end of the port cap, having female threads, is often very strong, for example, being a helical thread with continuous thread material supporting the leading edge of the thread. Such threads thus exhibit substantial stiffness even if made of relatively soft materials, such as polyethylene, polypropylene and the like.

In one embodiment, the port cap comprises a polymeric material and is a molded structure.

The port cap may include a thread configuration comprising a plurality of spaced apart thread segments which cooperate with the splines to secure the port cap to the port.

The port has a longitudinal axis, and the splines advantageously extend substantially parallel to the longitudinal axis.

In a very useful embodiment, the port, and, advantageously the port cap, are components of a luer fitting. Thus, the port may be considered as a luer port or a luer port component.

The number of splines may vary depending on various factors, for example, the specific application involved the size of the splines, the configuration of the splines, the material of construction of the splines and port cap and the like factors. In one embodiment, the number of splines is in the range of 2 to about 8. The splines are advantageously substantially equidistantly spaced apart, although the splines can be not equidistantly spaced apart.

Each of the splines may include an inner end secured to the port and an outer end extending radially outwardly away from the port. In one embodiment, each of the ports has a decreasing taper from the inner end to the outer end.

In one embodiment, the port has a longitudinal axis and each of the splines has an outer end extending radially outwardly away from the port with the outer end of each of the splines being non-parallel to the longitudinal axis of the port. The outer sidewall defining the port may also be non-parallel to the longitudinal axis of the port.

In a particularly useful embodiment, the outer end or edge of each of the splines is positioned at an angle relative to the longitudinal axis of the port with the angle being about 10° or less, for example about 5° less, such as an angle in a range of about 0.1° to about 2° or about 3°. Such angle, which can be considered a draft angle is useful in allowing removal of the port and splines from a molding apparatus during manufacture of the structure, and may vary depending, for example on the material of construction used.

In still another broad aspect of the present invention, port caps are provided which comprise a cap body having a closed end structure sized and adapted when the cap body is secured to a port having an open end to effectively cover the open end; and a sidewall coupled to the closed end structure and defining a hollow space sized and adapted to receive at least a portion of the port. The cap body may comprise a polymeric material, for example and without limitation, as set forth elsewhere herein with respect to the ports and port caps, and be a molded structure. The sidewall further defines a thread configuration produced using no unthreading core during molding of the cap body.

In one embodiment, the thread configuration of the sidewall comprises a plurality of spaced apart thread segments structured to cooperate with coupling structure, for example and without limitation, complementary threads, splines as described elsewhere herein, etc., of a port to secure the port cap to the port. For example, the thread configuration may have two spaced apart thread segments. Each of the thread segments may extend through less than about 180° or less than about 150° of the 360° of the inner circumference of the sidewall. Such spaced apart thread segments are effective in securing the port cap to the port and can be made by molding without using an unthreading core during molding of the body cap, thereby reducing the cost of producing such port caps.

Each and every feature described herein, and each and every combination of two or more of such features, is included within the scope of the present invention provided that the features included in such a combination are not mutually inconsistent.

These and other aspects of the present invention are set forth in the following detailed description and claims, particularly when considered in conjunction with the accompanying drawings in which like parts bear like reference numerals.

### BRIEF DESCRIPTION OF THE DRAWINGS

FIG. 1 is an exploded cross-sectional view of a splined female luer fitting component in accordance with the present invention with a male luer fitting component.

FIG. 2 is a cross-sectional view taken along line 2-2 of FIG. 1.

FIG. 3 is a cross-sectional view of the female and male luer fitting components of FIG. 1 coupled together.

FIG. 4 is a cross-sectional view of the female luer fitting component of FIG. 3 after the male luer fitting component has been removed.

FIG. 5 is an exploded cross-sectional view of another embodiment of a female luer fitting component and a valve member in accordance with the present invention with a male luer fitting.

FIG. 6 is a cross-sectional view taken along line 6-6 of FIG. 5.

FIG. 7 is a cross-sectional view similar to FIG. 6 showing another embodiment of a valve member in accordance with the present invention.

FIG. 8 is a cross-sectional view similar to FIG. 6 showing a further embodiment of a valve member in accordance with the present invention.

FIG. 9 is a cross-sectional view of the female luer fitting component of FIG. 5 partially coupled to a male luer fitting component.

FIG. 10 is a cross-sectional view of the female luer fitting component of FIG. 5 fully coupled to a male luer fitting component.

FIG. 11 is a cross-sectional view of the alternate female luer fitting component and valve member partially coupled to a male luer fitting component.

FIG. 12 is a cross-sectional view of the alternate female luer fitting component of FIG. 11 fully coupled to a male luer fitting component.

FIG. 13 is a bottom side view, in perspective, of a dust cap in accordance with the present invention.

FIG. 14 is a bottom plan view of the dust cap shown in FIG. 13.

FIG. 15 is a cross-sectional view of the female luer fitting component of FIG. 5 shown coupled to the dust cap of FIG. 13.

### DETAILED DESCRIPTION OF THE DRAWINGS

The following description emphasizes luer fittings and port caps, and valves and valve assemblies associated with luer fittings. Although the present invention is highly useful and effective in the luer fitting and port cap context, it should be noted that the present invention is appliable to other types of fittings and port caps.

In addition, the description below does not limit itself to any particular application for the present invention. It is to be understood that the present valve assemblies, valves, port caps and fluid ports may be employed in a wide variety of applications, such as medical applications, commercial applications, industrial applications and the like. Although the size of the present components and the materials of construction used in the present components may be selected at least in part to be compatible with the specific application involved and/or the specific environmental conditions to be encountered, the structure and functioning of the present components are substantially similar regardless of the application.

In one embodiment, the present components are useful in the medical field, for example, in conjunction or association with medical apparatus/devices and with auxiliary equipment used with such medical apparatus/devices. Examples of such medical apparatus/devices and auxiliary equipment include, without limitation, respiratory gas circuits, fluid infusion systems, catheter systems, surgical systems, suction applying devices, patient monitoring systems, fluid containers and the like. When used in conjunction or association with medical apparatus/devices and/or with auxiliary medical equipment, the present components are advantageously sized and comprise materials of construction so as to be compatible with the specific application involved, for example, to be compatible with the patient involved or being treated.

The drawings and description relate primarily to components which are generally circular in cross-section perpendicular to the longitudinal axis of the component.

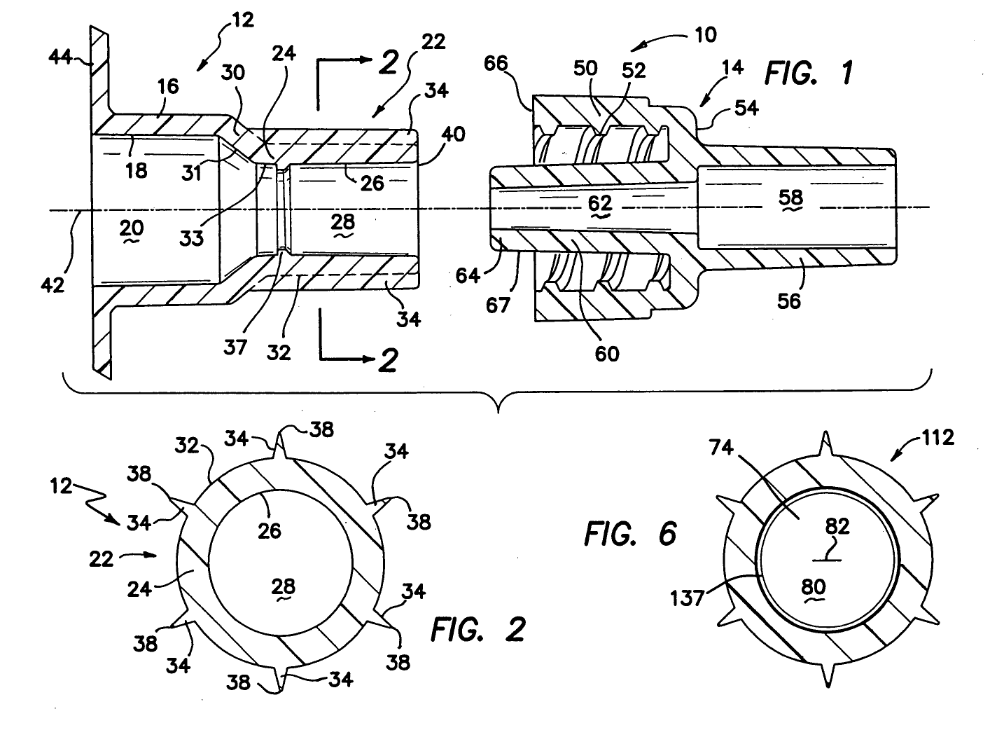

Referring now to the drawings, FIGS. 1 and 2 illustrate one aspect of the present invention in which a luer fitting, shown at 10, is provided. Fitting 10 includes a female luer fitting component 12 and a male luer fitting component 14. Female fitting component 12 includes a fluid port 16 with an interior sidewall 18 defining a hollow through space 20. Female fitting component 12 further includes a coupling portion 22 made up of a base 24 having an inner sidewall 26 defining a hollow passageway 28. An angled intermediate portion 30 including an inner intermediate sidewall 31. Base 24 includes an inner sidewall surface region 33 which is directly adjacent intermediate sidewall 31 and extends substantially parallel (except for a small draft angle) to the longitudinal axis 42 of the female component 12. Base 24 also includes an inwardly extending annular projection 37 which extends inwardly between sidewall 26 and sidewall surface region 33, as shown in FIG. 1. The functioning of the annular projection 37 is discussed elsewhere herein.

As best seen in FIG. 2, projecting radially outwardly from the outer surface 32 of base 24 are a series of equidistantly spaced apart splines 34. Each of the six (6) splines 34 shown in FIGS. 1 and 2 has a decreasing taper from the outer surface 32 of base 24 to the rounded spline tip 38. The splines 34 extend from the intermediate portion 30 to the distal end 40 of the female component 12. The splines 34 are configured so that the rounded spline tips 38 extend longitudinally at an angle of about 0.25° to about 1° relative to the longitudinal axis 42 of the female component 12 so that the splines 34 are slightly smaller at the distal end 40 relative to more proximally on base 24 of female component 12. This about 0.25° to about 1° angle, which may be considered a draft angle, is advantageous during production of female component 12 by molding to allow easy and successful removal of the female component from the molding apparatus. The draft angle may vary depending on a number of factors, for example, the size and configuration of the part being molded, the particular molding apparatus and process being utilized, the particular polymer being molded and the like factors.

A proximal flange 44 extends radially outwardly from the fluid port 16 and is effective in securing or bonding, for example, using conventional techniques such as heat and/or ultrasonic bonding, female component 12 to a system, apparatus or device in need of a luer fitting. Alternatively, flange 44 may be considered a part or component of the system, apparatus or device in need of a luer fitting. For example, female component 12 may be molded together with the part or component of the system, apparatus or device in need of a luer fitting.

The male luer fitting component 14 may be a standard or conventional fitting component, for example, such component as commonly used in the medical industry. Male luer fitting component 14, a threaded portion 50 is provided including internal threads 52. Threaded portion 50 is sized and adapted to be secured to the base 24 of the female component 12, as is discussed elsewhere herein. Extending from the back end 54 of threaded portion 50 is a conduit component 56 which defines a hollow conduit space 58. Conduit component 56 may be connected to a system, apparatus or device with which female fitting component 12 is associated, when the female component 12 and male component 14 are coupled together, to provide a desired product or service to such device, apparatus or system. Threaded portion 50 includes an internal component 60 defining an internal conduit hollow space 62 in fluid communication, for example, directly joined to, hollow conduit space 58. Internal component 60 includes a forward extending portion 64 which extends beyond the end 66 of the threads 52. The outer surface 67 of internal component 60 and the sidewall 26 of base 24 are complimentarily tapered so that internal component 60 can be easily fit into hollow passageway 28 when the fitting components 12 and 14 are coupled together.

Each of the female component 12 and the male component 14 is advantageously a single unitary structure. These components may be made of any suitable material or materials of construction effective to be structured and operate or function as described herein. In one embodiment, both the female component 12 and the male component 14 comprise one or more polymeric materials, for example, thermoplastic polymeric materials, such as polyolefins, polycarbonates, polyesters, polyamides and the like and combinations thereof. The female and male components 12 and 14 may comprise one or more materials conventionally included in luer fitting components, for example, in luer fitting components for medical applications. Useful female and male components 12 and 14 may comprise one or more polyolefins, such as polyethylene, polypropylene, ethylene/propylene copolymers and the like and combinations thereof.

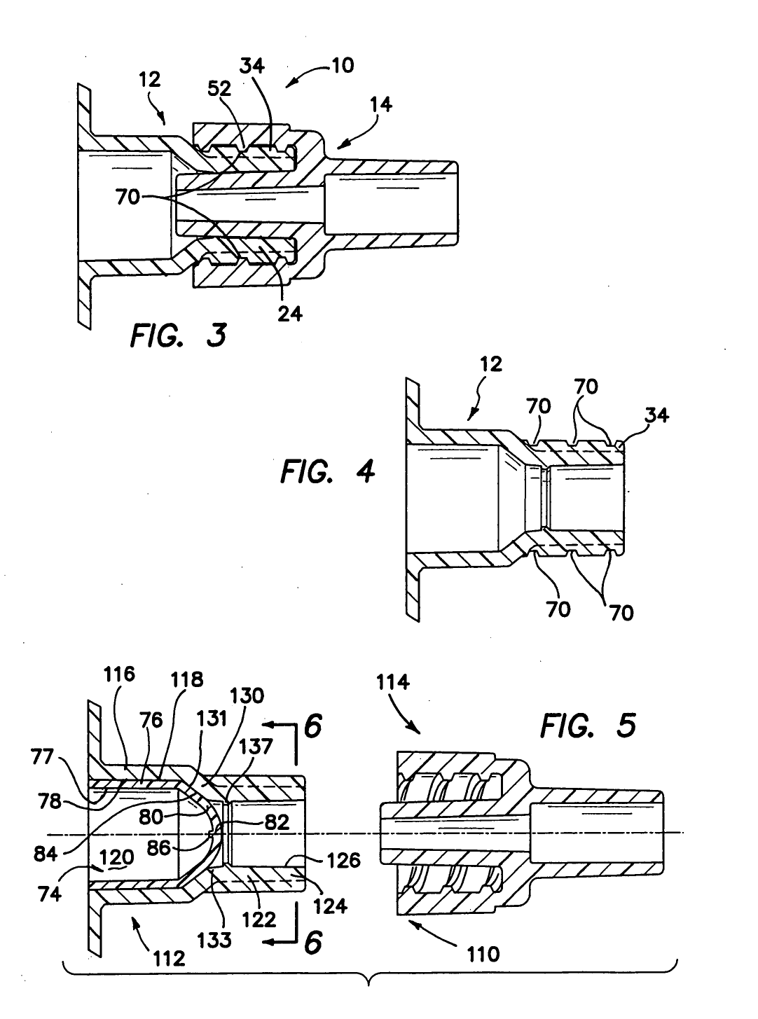

The splines 34 are structured or configured to yield when the internal thread 52 of the male component 14 is placed in contact with the splines and the male component 14 is rotated relative to the female component 12 and secured to the female component 12. The coupled female fitting component 12/male fitting component 14 combination, that is fitting 10, is illustrated in FIGS. 3 and 4. In effect, the thread 52 of the male component 14 creates thread-like grooves 70 in the splines 34 which, together with the thread 52 mated to the grooves 70 are effective in securing or coupling the female component 12 and male component 14 together, as shown in FIG. 3.

One advantage of employing splines 34 on female component 12 instead of full threads extending from the base 24 is ease of manufacture. Simply put, it is easier and less expensive to manufacture, for example, mold, a female fitting component 12 with two or more splines 34 parallel to the longitudinal axis of the fitting component than to manufacture a female fitting component with full threads circumscribing the base. It has been found that using splines, such as splines 34, to secure female and male fitting components, such as female and male luer fitting components 12 and 14, together is as effective in securing the female and male components together as a substantially identical set of fitting components in which the female fitting component includes fully formed threads circumscribing the base 24.

In addition, it has been found that the use of splines, such as splines 34, as described herein may be resistant to being stripped or even are strip proof. Thus, if the splines are sized and/or structured to be sufficiently resilient, such as being sufficiently thin and/or sufficiently pliable and/or sufficiently soft, for example, if the splines comprise polyolefins, such as polyethylene, polypropylene, ethylene/propylene copolymers and the like and combinations thereof, such splines have been found to be resistant to being stripped. For example, if a user turns the male fitting component 14 too hard against such splines so that the male fitting component bottoms out against the splines, it has been found that the splines do not strip, and the female fitting component 12 is not substantially damaged. Without wishing to limit the invention to any particular theory of operation, it is believed that such splines, for example relatively soft splines and/or splines comprising one or more polyolefins as described elsewhere herein, have sufficient resilience to return to their original configuration or at least return to a useable configuration sufficiently after the male fitting component 14 passes so that the female component 12 remains retained or secured to the male component 14, even after a deliberate attempt to strip the splines occurs.

In any event, this strip resistant spline feature of the present invention provides an additional advantage relative to the use of a female fitting component including full threads circumscribing the base of the female fitting component.

FIG. 5 illustrates another aspect of the present invention in which another luer fitting, shown as 110, is shown. Except as expressly described herein, luer fitting 110 is structured and functions similarly to luer fitting 10. Components of luer fitting 110 which correspond to components or features of luer fitting 10 are identified by the same reference numeral increased by 100.

Luer fitting 110 includes female luer fitting component 112 and male luer fitting component 114. One difference between female luer fitting component 112 and female luer fitting component 12 is the presence of valve member 74. Valve member 74 includes a valve body 76 carried by sidewall 118 of fluid port 116 of female component 112. The outer wall 78 of valve body 76 can be textured or roughened or otherwise structured to at least assist in holding, for example, frictionally holding, the valve body 76 to the sidewall 118. Alternately or in addition, the valve body 76 can be interference fitted in place against sidewall 118. For example, the valve body may be made slightly oversized relative to the hollow space 120 defined by sidewall 118 so that the valve body 76 is forced or wedged in place against the sidewall 118.

In one embodiment, the valve body 76 is carried by the sidewall 118 without using solvents or adhesives or other parts to facilitate securing the valve body to the sidewall. Using no solvents or adhesives or other parts to facilitate securing the valve body to the sidewall reduces the risk of contamination during use and, in addition, simplifies the manufacturing process to advantageously reduce costs.

The valve member 74 further comprises an end portion 80 which has a through slit 82. As shown in FIG. 5, end portion 80 has a cone or dome-like curved configuration with the slit 82 in a normal closed configuration. The outer circumferential surface region 84 of the end portion 80 is in contact with and supported by the conical, inner sidewall 131 of intermediate portion 130 of female component 112.

A rib region 86 of the end portion 80 is provided immediately surrounding the slit 82 and has an increased thickness relative to the thickness of the remainder of the end portion 80. For example, the thickness of the rib region 86 may be greater than the thickness of the remainder of the end portion by about 20% to about 100% or more. The thickness of the remainder of the end portion 80, as well as the thickness of the valve body 76 may vary over a relatively wide range, for example, depending on the size, composition and geometry or structure of the end portion 80 and valve member 76. The end portion 80 and valve body 76 may have the same thickness or different thicknesses. Such thicknesses, for example, in medical application, may be in a range of about 0.1 mm or less to about 1 mm or about 2 mm or more.

The combination of the support for the end portion 80 provided by conical inner sidewall 131 and the increased thickness of the rib region 86 is effective in maintaining the through slit 82 in the normally closed configuration, as shown in FIG. 5.

With the through slit 82 in the normally closed configuration, the valve member 74 is an effective two way valve against fluids passing through the end portion 80, particularly in applications in which the pressure differential across the end portion 80 is low, for example, on the order of about 15 psi or about 10 psi or less. This feature makes the present invention very useful in many medical applications and other low pressure differential applications. Valve member 74 is effective to self close, that is to self move from a position in which the through slit 82 is in the open configuration to a position in which the slit is in the closed configuration. Valve member 74 can release fluid in either direction once the cracking pressure of the valve is reached, which cracking pressure may be different in each direction.

The valve member 74, that is valve body 76 and end portion 80, is advantageously a single unitary structure.

The valve member 74, for example, the end portion 80, advantageously comprises a flexible material. One or more advantages of such flexibility are apparent with regard to the operation of the valve member 74. Any suitable material or combination of materials of construction may be employed in producing the valve member 74 provided that such materials yield a valve member which is structured and functions in accordance with the present invention.

In one very useful embodiment, the valve member 74 comprises one or more polymeric materials. Such polymeric materials for inclusion in the present valve member 74 include elastomeric polymeric materials, such as silicone rubbers, silicone elastomers, polyurethane elastomers, natural rubber, synthetic rubber, other polymeric elastomers and the like and combinations thereof.

The valve member 74 can be produced in any suitable way effective to provide an effective functional valve member in accordance with the present invention. In one embodiment, the valve member 74 is made using a combination, in liquid or suspension form, comprising suitable or appropriate amounts of each of a silicone elastomer precursor component, a crosslinking component and an ultraviolet (UV) light initiator component. A mandrel, for example, having an outer surface shaped as the negative of the inner surface 77 of the valve member 74, is provided and is coated with the liquid suspension. The liquid suspension on the mandrel is then subjected to ultraviolet light effective in polymerizing and/or curing the precursor component and crosslinking component to form a silicone elastomer. The through slit 82 is cut in the silicone elastomer, for example, using a knife or other blade-like device. The silicone elastomer is removed from the mandrel and is ready to be placed in the female luer fitting component 112 as shown in FIG. 5.

It should be noted that other methods of producing the present valve member 74 may be employed. For example and without limitation, conventional and well known polymerization and/or polymer forming techniques may be used.

The present female fitting component 112 includes an annular projection 137 extending inwardly between sidewall 126 and sidewall surface region 133, as shown in FIG. 5. The functioning of the annular projection 137 is discussed elsewhere herein.

FIG. 6 shows the single through slit 82 in the end portion 80 of the valve member 74 in place in female fitting component 112. Annular projection 137 is also shown in FIG. 6.

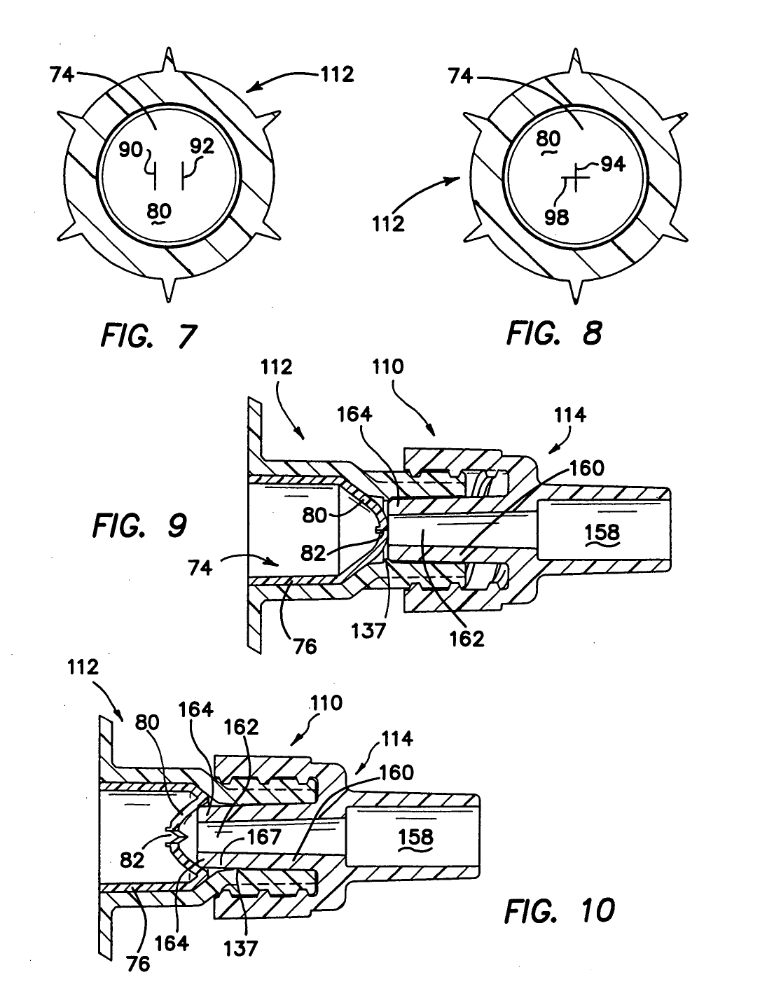

FIG. 7 shows another embodiment of valve member 74 in place in female luer fitting component 112 in which two non-intersecting slits 90 and 92 are placed in end portion 80 in place of through slit 82. FIG. 8 shows a further embodiment of valve member 74 in place in female luer fitting component 112 in which two intersecting slits 94 and 98 are placed in end portion 80 in place of through slit 82. Except for the presence of the different slit configurations described above, the embodiments of FIGS. 7 and 8 are structured and function similarly to the embodiment shown in FIG. 5. It should be noted that other slit configurations may be employed in accordance with the present invention and such other slit configurations are included within the scope of the present invention.

With reference to FIGS. 9 and 10, male fitting component 114 is shown being attached to female fitting component 112. As shown in FIG. 9, the forward extending portion 164 of internal component 160 of male fitting component 114 is at the point where the portion 164 is in close proximity to end portion 80. At this point, forward extending portion 164 comes into close proximity to and/or in contact with annular projection 137. This contact provides the user, that is a person, coupling the fitting components 112 and 114 together an indication, for example, a tactile indication, that the end portion 80 of valve member 74 is about to be contacted with the forward extending portion 164 of male fitting component 114. The user understands that this indication means that he/she should proceed cautiously with coupling the female and male fitting components 112 and 114 together in order to avoid damaging the valve member 74 and to obtain a secured, sealed coupling of the fitting components 112 and 114. Thus, prior to the point where the forward extending portion 164 causes the inversion of the end portion 80, the forward extending portion 164 comes into sealing contact with annular projection 137. In this manner the fitting components 112 and 114 are coupled together to form a substantially fluid tight seal before the through slit 82 is placed in the open configuration.

In FIG. 10, the forward extending portion 164 has contacted the end portion 80 and has caused an inversion of the end portion 80. That is, the forward extending portion 164 has contacted the end portion 80 with sufficient mechanical pushing force to move the end portion from being curved outwardly away from the valve body 76 (FIG. 9) to being curved inwardly toward the valve body 76 (FIG. 10). This, in turn, results in moving the through slit 82 into the open configuration, as shown in FIG. 10. It is important to note that the fitting 110 is structured so that the forward extending portion 164 does not put undue pressure on the end portion 80 so that the valve member 74 is not damaged even though the through slit 82 is effectively opened.

In addition, as the forward extending portion 164 pushes against end portion 80 to open through slit 82, the outer surface 167 of internal component 160 of the male fitting component 114 remains in sealing contact with inwardly extending projection 137, as shown in FIG. 10. This sealing contact provides a fluid tight seal between the female and male fitting components 112 and 114 while or when the through slit 82 is in the open configuration. This seal provides for very effective and secure transport of fluids through the open through slit 82 with substantially reduced risk of contamination or other interference from environmental factors and the like.

It should be noted that inward projection 37 on female fitting component 12 may provide a similar fluid tight seal when fitting components 12 and 14 are coupled together even through no valve, such as valve member 74, is present. This embodiment is included within the scope of the present invention.

With the male fitting component 114 and female fitting component 112 positioned in sealing relationship as described and as shown in FIG. 10, fluid or other material can be passed through the hollow conduit space 158 and internal conduit hollow space 162 of male component 114, and through the open through slit 82 and into the hollow space 20 of the female fitting component 112. Thus, material can be provided through the open through slit 82 without the use of a needle or other device.

Similarly, if it is desired to remove material, for example, by suctioning, from space 120 into the hollow conduit spaces 162 and 158 of the male component 114, such transfer of material can be made while the through slit 82 is maintained in the opened position.

Once the material transfer has occurred, the male fitting component 114 can be removed from the female fitting component 112. As the forward extending portion 164 of the male fitting component 114 is moved out of contact with end portion 80, outer surface 167 of internal component 160 remains in sealing contact with annular projection 137. The end portion 80 of the valve member 74 reverts to the normal curved dome or cone configuration with the through slit 82 in its normally closed configuration. In such normally closed configuration, valve member 80 again acts as a two way valve. For a short period of time, after through slit 82 returns to the normally closed configuration, outer surface 167 remains in sealing contact with annular projection 137. Such sealing contact is broken as forward extending portion 164 is moved further away from end portion 80.

It should be noted that valve member 74 may be used in combination with a female fitting component which, includes full threads in place of the splines as described herein, and such embodiment including a fully threaded female fitting component is included within the scope of the present invention.

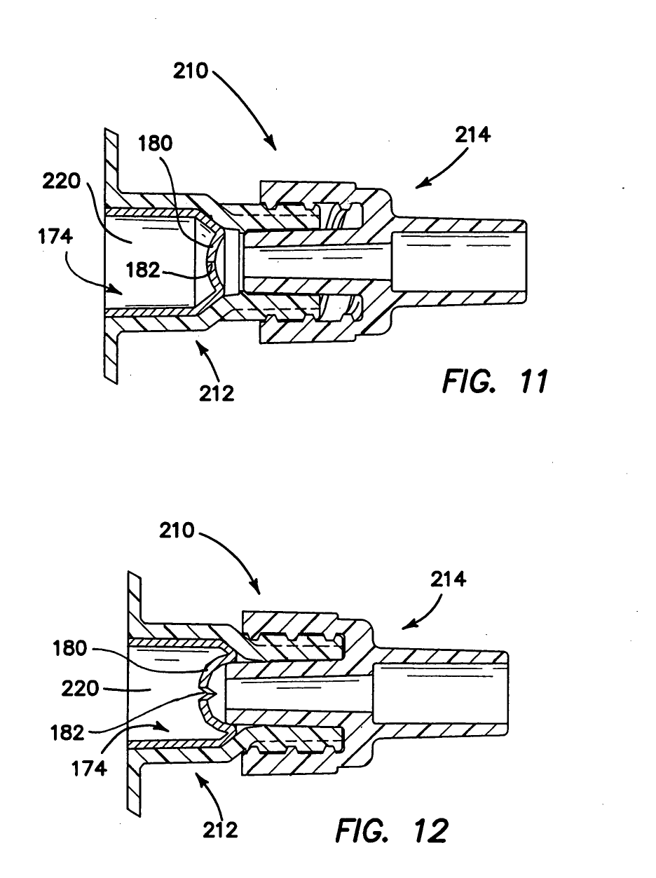

FIGS. 11 and 12 illustrate an alternate luer fitting, shown as 210. Except as expressly described herein, alternate luer fitting 210 is structured and functions similarly to luer fitting 110. Components of alternate luer fitting 210 which correspond to components or features of luer fitting 110 are identified by the same reference numeral increased by 100.

Alternate luer fitting 210 includes female fitting component 212 and male fitting component 214. The primary difference between the alternate luer fitting 210 and the luer fitting 110 relates to the configuration of the end portion 180 of the valve member 174 with the through slit 182 in the normally closed configuration, as shown in FIG. 11. In addition, as shown in FIG. 11 and 12, the thickness of the end portion 180 is substantially uniform, and does not include a thicker rib region, such as rib region 86 shown best in FIG. 9. It should be noted that end portion 180 can include such a rib region and such an embodiment is included within the scope of the present invention.

The end portion 180 of valve member 174 is structured to be curved inwardly toward the valve body 176 with the through slit 182 in the normally closed configuration, for example, as shown in FIG. 11. This inwardly curved closed configuration/structure of valve member 174 has been found to provide effective valving against increased pressures, particularly in the hollow space 220 defined by valve member 174.

As shown in FIG. 12, the through slit 182 is opened, using male fitting component 214 similarly to how male component 114 is used, to push against the end portion 180. In this case, such pushing causes the end portion 180 to move further inwardly, causing the through slit 182 to open. The through slit 182 can be closed by removing the male component 214 from the female component 212. This causes the end portion 180 to revert to its original or normal configuration. As shown in FIG. 11, with the through slit 182 in it's normally closed configuration.

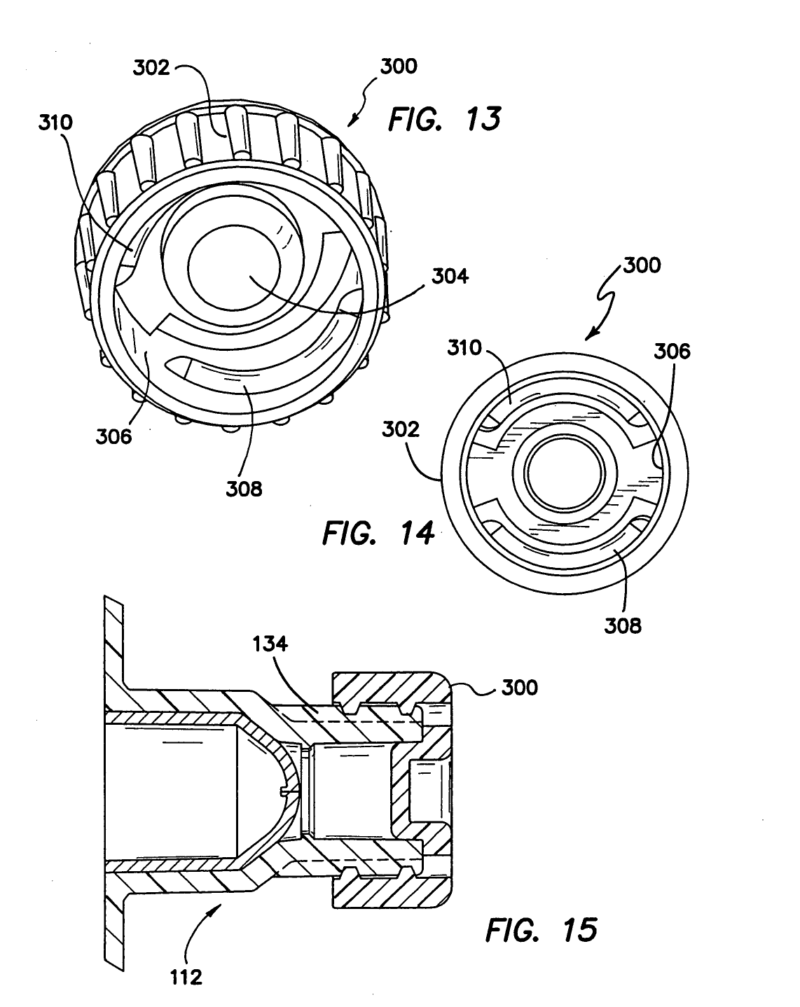

FIGS. 13, 14 and 15 show a dust cap 300 in accordance with the present invention. Dust cap 300 may be employed on female fitting component 112, as shown in FIG. 15 when it is desired to protect the fitting component from environmental contamination.

Dust cap 300 includes a sidewall 302, an inwardly extending end plug 304 and an inner sidewall 306. A pair of spaced apart thread segments 308 and 310 are provided extending radially inwardly from the inner sidewall 306. Each of the spaced apart thread segments 308 and 310 extend through about 130° to about 150° of the full 360° circumference of the inner sidewall 306 of the cap 300.

The spaced-apart thread segments 308 and 310 are designed to be secured to the female fitting component 112 by placing the cap 300 so that the spaced apart thread segments 308 and 310 come in contact with the splines 134 so that upon rotation of the cap relative to the female fitting component 112 the cap becomes secured to the female fitting component 112.

An important advantage of the present dust cap 300 is the provision of the spaced apart thread segments 308 and 310. Dust cap 300 may be formed, for example, by injection molding of one or more polymeric materials, such as one or more thermoplastic polymeric materials as described elsewhere herein, without using an unthreading core during molding of the cap. Thus, molding the dust cap 300 with spaced apart thread segments 308 and 310 is easier and less expensive than producing a similar dust cap in which a full thread, circumscribing the entire inner sidewall 306 of the dust cap 300. Moreover, the dust cap 300 performs as effectively as does a similar dust cap with such a full thread.

It should be noted that dust cap 300 may be used in combination with a female fitting component which includes full threads in place of the splines as described herein, and such embodiment including a fully threaded female fitting component is included within the scope of the present invention.

The following patents are identified: Clawson et al, U.S. Pat. No. 6,095,135; Clawson, U.S. Pat. No. 6,105,576; Clawson et al, U.S. Pat. No. 6,363,930; Clawson et al, U.S. Pat. No. 6,415,788; Spademan, U.S. Pat. No. 3,853,127; Handman, U.S. Pat. No. 4,244,478; Shimonaka et al, U.S. Pat. No. 4,809,679; Newgard et al, U.S. Pat. No. 4,874,377; Stull, U.S. Pat. No. 5,071,017; McLaughlin et al, U.S. Pat. No. 5,125,903; McPhee, U.S. Pat. No. 5,199,948; Behnke et al, U.S. Pat. No. 5,354,275; Siegal et al, U.S. Pat. No. 5,549,577; Leinsing, U.S. Pat. No. 5,676,346; Leinsing, U.S. Pat. No. 6,142,446; Leinsing et al, U.S. Pat. No. 6,706,022; Leinsing et al, U.S. Pat. No. 6,802,490; and Newton et al, U.S. Pat. No. 6,883,778.

The disclosure of each of the patents and publications identified herein is incorporated in its entirety herein by reference.

While this invention has been described with respect to various specific examples and embodiments, it is to be understood that the invention is not limited thereto and that it can be variously practiced within the scope of the following claims.

1. A valve assembly comprising
a fluid port comprising a sidewall defining a hollow through space; and
a valve member comprising a valve body carried by the sidewall, and an end portion coupled to the sidewall including an outer surface and at least one through slit having a normally closed configuration and an open configuration with the outer surface of the end portion curved inwardly toward the sidewall.

2. The valve assembly of claim 1 wherein the valve member is a single unitary structure.

3. The valve assembly of claim 1, wherein the end portion is structured so that the outer surface of the end portion extends away from the valve body when the at least one through slit is in the normally closed configuration.

4. The valve assembly of claim 3, wherein the end portion is structured to invert when a sufficient mechanical pushing force is applied to the end portion, thereby causing the at least one through slit to open enough to allow fluid to pass through the end portion.

5. The valve assembly of claim 1, wherein the end portion is structured so that the outer surface of the end portion extends toward the valve body when the at least one through slit is in the normally closed configuration.

6. The valve assembly of claim 5, wherein the end portion is structured to move further inwardly toward the valve body when a sufficient mechanical pushing force is applied to the end portion, thereby causing the at least one through slit to open enough to allow fluid to pass through the end portion.

7. The valve assembly of claim 1, wherein the end portion has a thickness, and a rib area of the end portion in proximity to the at least one through slit has a local thickness greater than the thickness to the end portion.

8. (canceled)

9. The valve assembly of claim 8, wherein the fluid port includes a support surface in contact with an outer region of the end portion when the at least one through slit is in the normally closed configuration, the support surface being effective in maintaining the at least one through slit in the normally closed configuration.

10. (canceled)

11. (canceled)

12. (canceled)

13. (canceled)

14. The valve assembly of claim 1, which is structured to be effective as a check valve with only a low pressure differential across the at least one through slit in the normally closed configuration.

15. (canceled)

16. The valve assembly of claim 1, wherein the valve body is frictionally held to the sidewall.

17. The valve assembly of claim 1, wherein the valve body is interference fitted to the sidewall.

18. (canceled)

19. The valve assembly of claim 1, wherein the at least one through slit is mechanically openable without passing an opening device into or through the at least one through slit.

20. (canceled)

21. The valve assembly of claim 1, wherein the fluid port is structured to form a seal with an opening device structured to mechanically open the at least one through slit.

22. (canceled)

23. The valve assembly of claim 1, wherein the sidewall of the fluid port includes an annular inwardly extending projection distal of the valve member, the projection being structured to form a seal with an opening device structured to mechanically open the at least one through slit.

24. (canceled)

25. The valve assembly of claim 1, wherein the fluid port is a component of a luer fitting.

26. The valve assembly of claim 25, wherein at least one through slit is openable by another component of a luer fitting in combination with the fluid port.

27. (canceled)

28. (canceled)

29. A valve assembly comprising:
a fluid port comprising a solid sidewall defining a hollow through space; and
a valve member comprising a valve body carried by the sidewall, and an end portion, coupled to the valve body, having a curved structure including at least one through slit in a normally closed configuration.

30. The valve assembly of claim 29, wherein the curved structure of the end portion extends away from the valve body and is structured to invert when a sufficient mechanical pushing force is applied to the end portion, thereby causing the at least one through slit to open enough to allow fluid to pass through the end portion.

31. The valve assembly of claim 29, the curved structure of the end portion extends toward the valve body is structured to move further toward the valve body when a sufficient mechanical pushing force is applied to the end portion, thereby causing the at least one through slit to open enough to allow fluid to pass through the end portion.

32. (canceled)

33. (canceled)

34. (canceled)

35. (canceled)

36. (canceled)

37. (canceled)

38. (canceled)

39. (canceled)

40. The valve assembly of claim 29, wherein the fluid port is structured to form a seal with an opening device structured to mechanically open that at least one through slit.

41. (canceled)

42. (canceled)

43. The valve assembly of claim 29, wherein the fluid port is a component of a luer fitting.

44. (canceled)

45. (canceled)

46. (canceled)

47. A valve member comprising:
a valve body comprising a wall defining a hollow space; and
an end portion, coupled to the valve body, having a curved outer surface, the end portion includes at least one through slit in a normally closed configuration extending through the curved outer surface, the at least one through slit in the normally closed configuration is effective in preventing fluid from at least one of (a) entering the hollow space through the end portion and (b) leaving the hollow space through the end portion.

48. (canceled)

49. The valve member of claim 47, wherein the curved outer surface extends away outwardly from the valve body when the at least one through slit is in the normally closed configuration.

50. The valve member of claim 47, wherein the curved outer surface extends inwardly toward the valve body when the at least one through slit is in the normally closed configuration.

51. (canceled)
